(19) United States
(12) Patent Application Publication
(10) Pub. No.: US 2003/0088793 A1
(43) Pub. Date: May 8, 2003

(54) Managing customized menus across multiple imaging devices

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/011,633

(22) Filed: Nov. 6, 2001

(51) Int. Cl. H04L 9/32

(52) U.S. Cl. 713/202

(57) ABSTRACT

Apparatus and methods that allow for the acquisition of customized imaging device menus from source imaging devices and configuration of versions of the customized imaging menus across one or more imaging devices or classes of imaging devices in a networked imaging device system. The customized imaging device menus can be configured for one or more classes of users, administrators, location, or specialized purposes. This allows an administrator to quickly and easily customize the interface of one or more imaging devices on a network to fit users needs, device purpose, and/or business expectations.

### TECHNICAL FIELD OF THE INVENTION

The present invention relates generally to imaging device customized menus and in particular the present invention relates to management and configuration of customized imaging device menus across multiple imaging devices in a network.

### BACKGROUND OF THE INVENTION

Computing devices are typically coupled to networks in modern computing environments. Networks in this definition include fiber optic, wire, wireless, and virtual, such as a virtual private network (VPN). In particular, imaging devices, such as printers, projectors, displays, and faxes are typically networked in modem computing environments. These imaging devices are typically set up and configured through a built-in network interface that allows them to be communicated with and configured remotely over a network. Imaging devices in organizations are typically implemented as networked imaging service providers in computer networks. In this disclosure imaging devices are intended to include, but are not limited to, printers, multi-function copiers, digital projectors, faxes, terminals, and other such imaging devices.

When being managed or queried over the network, the imaging devices generally require a management facility, program, or protocol, generally referred to as management facilities, to interface with. These management facilities are typically specific to the device, class of device, or even device manufacturer, that is being managed or communicated with. The management facilities for imaging devices can take many forms. In this disclosure, management facilities are intended to include, but are not limited to, management programs running on multiple platforms, software drivers, and other such management programs.

FIG. 1 details a simplified diagram of an imaging device system as background. FIG. 1 includes a network backplane 100, imaging devices 102, a server 106, workstations 108, and a management facility 110. Each imaging device 102 contains device configuration information and device firmware/software. Each imaging device 102 further gathers it own usage information and statistics, which can include such information as number of pages imaged, number of jobs received, number of copies of jobs received, and numbers of errors. The management facility 110 allows management and querying of the imaging devices 102 across the network backplane 100. Each imaging device 102 communicates to the management facility 110 across the network backplane 100.

When operating imaging devices in an imaging device system on a network, each imaging device typically has a menu that allows administrators and end users to manipulate aspects of the imaging device. These aspects include, but are not limited to, the setup, configuration, function, mode, and jobs being processed on the imaging device. This menu is generally available to the administrator or end user through a control panel on the imaging device or is accessed over the network with an appropriate protocol or program, such as the management facility 110. These imaging device menus commonly are static in nature, appearance, and options presented to the end user or administrator. The imaging device menu commonly varies only across manufacturer or original equipment manufacturer (OEM), or between the menu presented to an administrator or end user.

Often, it is preferable that an imaging device system have a specialized menu or menus for convenience of the end users or administrator. Examples of such circumstances include, but are not limited to, a network location, a business, a business location, specific classes of users, classes of administrators, equipment providers, manufacturers, or original equipment manufacturers (OEMs). Additionally, in many situations an imaging device or a class of imaging devices of an imaging device system may have specialized tasks or purposes. In such specialized tasks or purposes it is desirable to have a specialized menu or menus specific to the task for convenience of the end users or administrator. Unfortunately administrators typically cannot easily make changes in the imaging device menus for network location, business, classes of users, classes of administrators, equipment provider, manufacturer, OEM, or imaging device purpose. Thus, operating and managing a system of imaging devices with undifferentiated and static imaging device menus is difficult and inconvenient for the network administrator and users.

For the reasons stated above, and for other reasons stated below which will become apparent to those skilled in the art upon reading and understanding the present specification, there is a need in the art for a method of conveniently operating and managing imaging device menus in a network environment.

### SUMMARY OF THE INVENTION

The above-mentioned problems with organizing and managing imaging device menus in imaging device systems are addressed by the present invention and will be understood by reading and studying the following specification.

In one embodiment, an imaging device system includes a network, a plurality of imaging devices coupled to the network, and a management facility coupled to the network, wherein the management facility is adapted to acquire a menu configuration from one or more source imaging devices and to configure the menu configuration to one or more selected imaging devices of the plurality of imaging devices.

In another embodiment, a method of configuring a menu configuration in an imaging device system includes obtaining a menu configuration from one or more source imaging devices, and setting the menu configuration of one or more selected imaging devices of the imaging device system.

In a further embodiment, a computer-usable medium has computer readable instructions stored thereon for execution by a processor to perform a method. The method includes obtaining a menu configuration from one or more source imaging devices, and setting the menu configuration of one or more selected imaging devices of the imaging device system.

In yet a further embodiment, an imaging device includes a network interface, and an embedded management facility coupled to the network interface, wherein the management facility is adapted to acquire a menu configuration from one or more source imaging devices and to configure the menu configuration to one or more selected imaging devices of an imaging device system.

### BRIEF DESCRIPTION OF THE DRAWINGS

FIG. 1 is a simplified diagram of an imaging device system.

FIG. 2 is a simplified diagram of a configurable menu of an embodiment of the present invention.

FIGS. 3A, 3B, 3C, and 3D, are simplified diagrams of image device system embodiments of the present invention.

FIG. 4 is a simplified diagram of an imaging device system embodiment of the present invention.

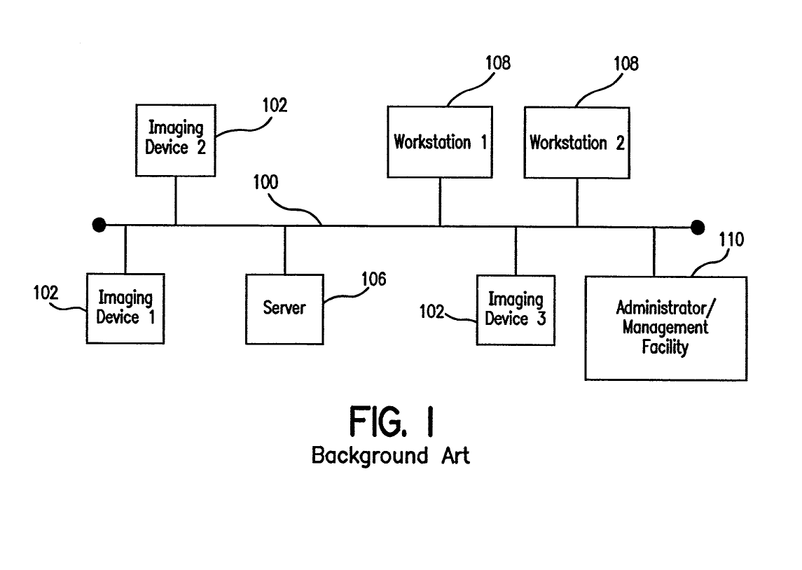

### DETAILED DESCRIPTION OF THE INVENTION

In the following detailed description of the preferred embodiments, reference is made to the accompanying drawings that form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

The appeal of customizing elements of a network for convenience of use and management by network administrators is a common objective. Towards this goal, the customizing of the imaging device menus for users of the imaging device systems, a commonly used aspect of a network, is highly desirable. Embodiments of the present invention include management facilities and imaging devices of an imaging device system that allow configurable menus to be set across one or more imaging devices of the imaging device system. This allows for specialized menus to be designed for multiple classes of users, administrators, and specific uses in the imaging device system. These specialized menus can then be distributed to one or more imaging devices of the imaging device system, or one or more classes of imaging devices of the imaging device system. An imaging device system for purposes of this disclosure is defined as multiple imaging devices that are networked or otherwise linked.

Specific embodiments of the present invention include, but are not limited to, imaging device systems that include imaging devices that store one or more customized imaging device menus for one or more classes of users or administrators, or one or more specific uses of the imaging device, allowing imaging device menu customization for one or more classes of users, administrators, functions, and imaging device dedicated purposes; imaging devices that store the one or more customized imaging device menus internally on multiple media and formats; imaging device systems that store one or more customized imaging device menus on one or more imaging devices on a network; imaging devices that load one or more customized imaging device menus from an external source, input one or more imaging device menus manually, or discover a list of imaging devices from a network to load one or more customized imaging device menus into; imaging devices that can maintain and update one or more customized imaging device menus from a network to keep the one or more imaging device menus current; imaging devices that can store one or more customized imaging device menus that include menu items that display supplemental information about the imaging device, such as, imaging device type, imaging device features, media types, marking material types (such as ink, toner, thermal material, etc.), imaging device configuration, imaging rate, imaging device usage information (job origin, number of pages imaged, number of copies of jobs received, number of errors, types of errors, marking material usage, marking material level, etc.), imaging device status, etc.; and imaging devices that can store one or more customized imaging device menus and include an embedded management facility or function, such as an embedded webserver.

In embodiments of the present invention, the management facility may be a function of a network device, such as a master imaging device, server, workstation or other similar device. The management facility is generally a software program running on some platform or operating system, but such functionality could be expressed in firmware or even hard-coded in a device such as an application-specific integrated circuit (ASIC) chip. Imaging devices that incorporate an embedded management facility are also known. An example of such are imaging devices with embedded webservers, allowing management of themselves and other imaging devices on the network through the embedded webserver as described in the U.S. patent application Ser. No. ______ (Attorney Docket No. 10008080-1), which is commonly assigned and is incorporated herein by reference. In general, however, the management facility includes a set of computer-readable instructions stored on a computer-usable medium for execution by a processor. Examples of computer-usable medium include removable and non-removable magnetic media, optical media, dynamic random-access memory (DRAM), static random-access memory (SRAM), read-only memory (ROM) and electrically-erasable and programmable read-only memory (EEPROM or Flash).

As stated above, imaging device embodiments of the present invention store customized menus, which allows the presentation of differing customized menus across one or more imaging devices, classes of imaging devices, or specialized purpose imaging devices of the network imaging device system. This permits imaging device menu customization by management facilities for one or more classes of users, administrators, functions, and imaging device dedicated purposes in the network imaging device system. It also allows for ease of management of the imaging device system and aids user utilization of the imaging device system. Additionally, imaging device menu customization for equipment provider, business, network, or location is allowed without the need for reprogramming of the managed imaging device by the manufacturer or a trained technician. In embodiments of the present invention it is preferred that each imaging device or imaging device class that share custom menus are similar to the other imaging devices or members of the imaging device class. Similar imaging devices, for the purposes of this disclosure, are defined as imaging devices similar with regard to manufacturer, imaging device type, or features. Imaging device embodiments of the present invention are particularly advantageous where a management facility is embedded in one or more of the imaging devices of the imaging device system, such as the above-detailed embedded webserver management facility.

Embodiments of the present invention that let customized imaging device menus to be managed across an imaging device system allow for increased ease of management and user utilization of the modified imaging devices. Examples of possible menu customizations and imaging device system changes with embodiments of the present invention include, but are not limited to, the following: the setting-up of specialized menus for classes of users with varying function and control over an imaging device (such as their local default printer) or a class of imaging devices (such as, other general-use printers, multi-function copiers, or digital projectors) in a network imaging device system; the setting-up of classes of administrators with varying ability to manage imaging devices and update or configure the imaging devices or imaging jobs being processed on the imaging device which would allow for useful delegation of administrative duties to reduce the load on system administrators; the configuring of menus or sets of menus that are accessible with entry of a specific username and password or personal identification number (PIN) access to specific imaging device menus and functions, allowing for increased security and/or user tracking; the customization of imaging devices tasked to specific purposes, such as digital projection, check printing, printing at embedded production line sites, printing at web kiosks, etc; the customization of menus with situation specific sub-menus of an imaging device or class of imaging devices to account for specialized utilizations or features of the imaging device or class of imaging devices; and, the customization of imaging device menus, logos, and appearance for a particular imaging device provider, reseller, OEM, business, location, building, business group, or network association.

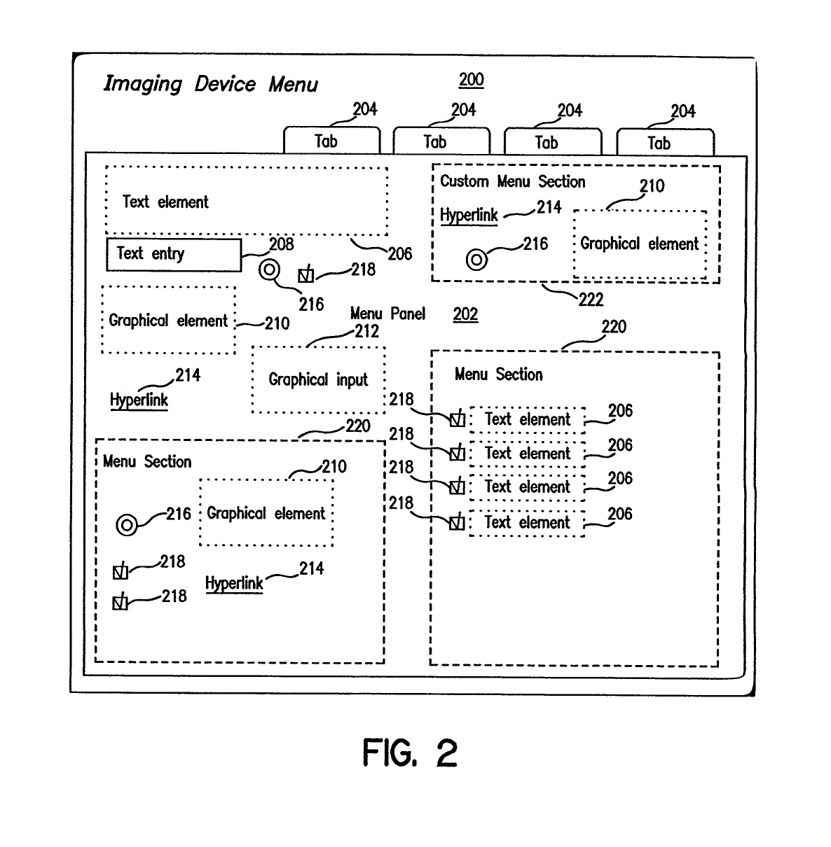

An example of imaging devices with configurable menus are described in the U.S. patent application Ser. No. 09/928,577 filed Aug. 13, 2001 titled “Customizable Control Panel Software” by Travis J. Parry, which is commonly assigned and is incorporated herein by reference. FIG. 2 describes an example of a configurable menu panel for an embodiment of the present invention and is described herein for purposes of illustration. In FIG. 2, the configurable imaging device menu interface 200 contains multiple menu panels 202 that are accessed through one or more menu tabs 204. In the configurable imaging device menu interface 200, menu tabs 204 can be added or subtracted to give more or less menu panels 202 as needed. Each menu panel 202 is constructed of one or more text elements 206, text inputs 208, graphical elements 210, graphical inputs 212, hyperlinks 214, buttons 216, and checkboxes 218. In addition, the menu panel 202 allows for inclusion of manufacturer-supplied pre-configured menu sections 220 that contain the above-listed menu panel elements of one or more text elements 206, text inputs 208, graphical elements 210, graphical inputs 212, hyperlinks 214, buttons 216, and checkboxes 218. The menu sections 220 are generally programmed for common or popular functions and functionality. Such pre-configured menu sections 220 are pre-validated and can allow for customized menus that are highly stable. Custom menu sections 222 that are programmed by a reseller, OEM, administrator, etc. and incorporate the common menu panel elements are also allowed. It is noted that other forms of configurable imaging device menus and manners of assembly are possible and can be utilized in embodiments of the present invention.

The one or more configured menus can be stored in imaging device embodiments of the present invention in multiple forms of internal storage media. Such media include, but are not limited to, removable and non-removable magnetic media, optical media, dynamic random-access memory (DRAM), static random-access memory (SRAM), and electrically-erasable and programmable read-only memory (EEPROM or Flash). The format of the one or more configured menus can be stored in embodiments of the present invention can be in forms that include, but are not limited to, formatted media blocks, sequential lists, linked lists, and formatted files of a specified file system type.

The specific customized menus that are to be configured into one or more imaging devices or class of imaging devices of an imaging device system embodiment of the present invention can be entered in multiple manners. One such manner is designing and entering the customized menu configuration directly into the management facility via a text or graphic user interface. Another manner is to load the customized menu configuration to the management facility from an external menu editing program. A further manner is loading a menu configuration from a source imaging device that already has one or more of the desired customized menus configured into it, allowing that device's menus to essentially be cloned to other imaging devices in the network. It is noted that other manners of generating or acquiring a imaging device menu exist and should be apparent to those skilled in the art with the benefit of this disclosure.

Once the desired customized menu configuration is acquired or located, it can be stored prior to configuration to facilitate the configuration of the imaging device or to aid later retrieval of the customized menu configuration. This storage location can be the management facility, a network site, or an imaging device of the network.

To accomplish the configuration of the customized menus into imaging devices of the managed imaging device system, the administrator selects one or more of the customized menus at the management facility and one or more target imaging devices or one or more target classes of imaging devices that are to be configured with the selected menus. The administrator then commands the management facility to configure the selected target imaging devices or target classes of imaging devices with the chosen menu configuration. Alternatively, the administrator can command the selected target imaging devices to configure themselves directly from a storage location of the selected menu configuration, which as stated above, can be the management facility itself, a network site, or an imaging device of the network. An optional “mask” can be specified to not configure certain of the chosen custom menus in selected target imaging devices. This allows desired local menu configurations to be kept in these target imaging devices or classes of imaging devices. An example of such a configuration operation would be a network-wide update of baseline imaging device menus in an imaging device system, where it is not desired to update the specific menu customizations of special imaging devices or classes of imaging devices.

In embodiments of the present invention, the target imaging devices can be selected from a list of imaging devices held internally in the management facility. This list of imaging devices of the imaging device system can be entered into the management facility in multiple manners which include, but is not limited to, manual entry by an administrator, loading the list of imaging devices from an external source, or generating the list of imaging devices by “discovering” imaging devices on the network. The process of discovery of imaging devices on a network is well known in the art and therefore will not be covered in the present disclosure. Once the list of similar imaging devices is entered, loaded, or discovered the administrator selects the desired target imaging devices and commands the management facility to configure the customized menu into the target imaging devices.

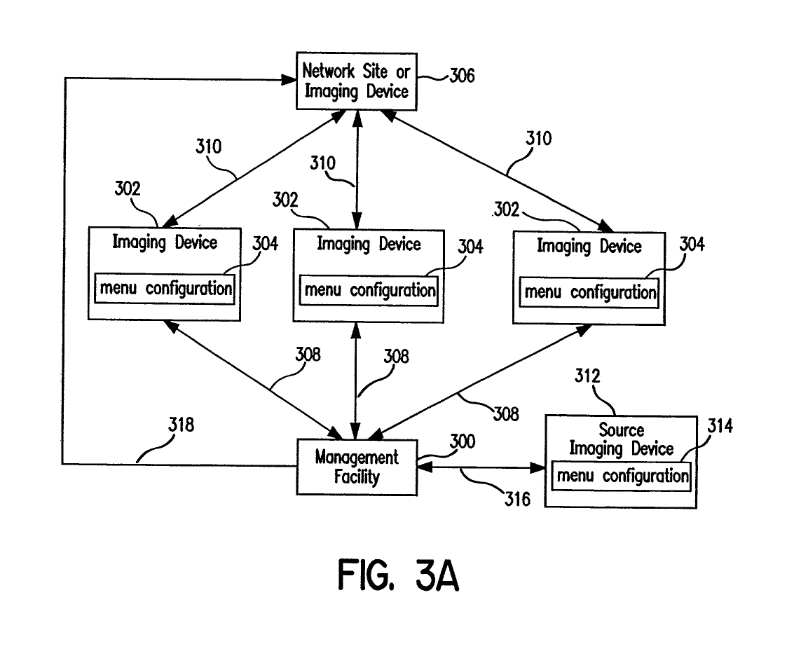

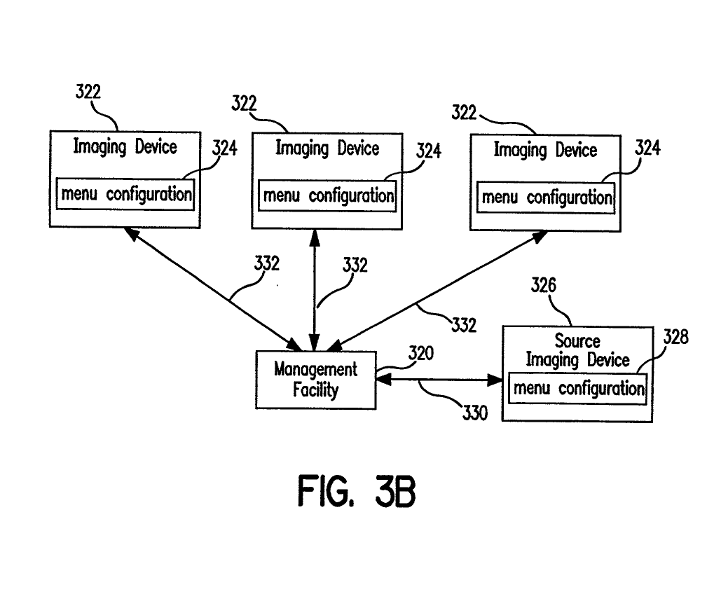

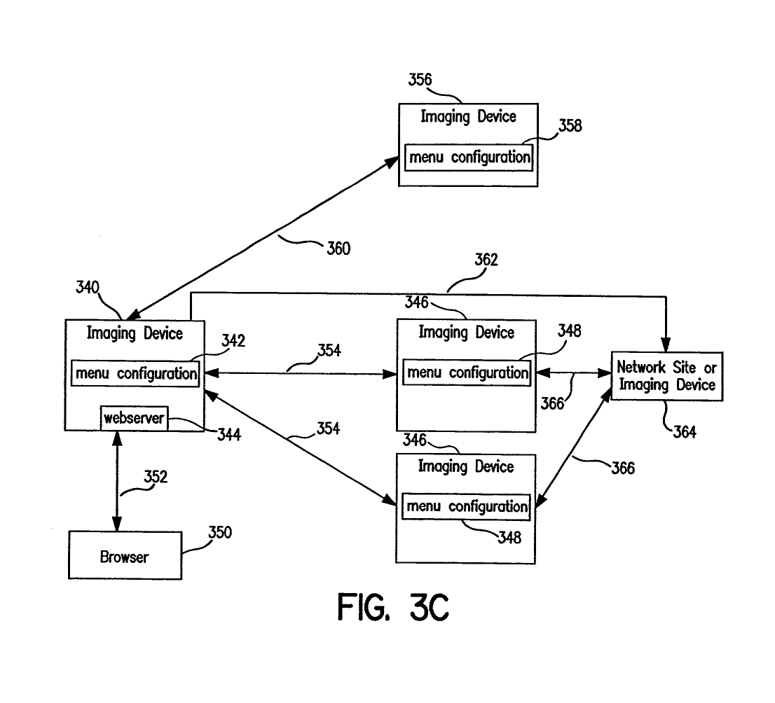

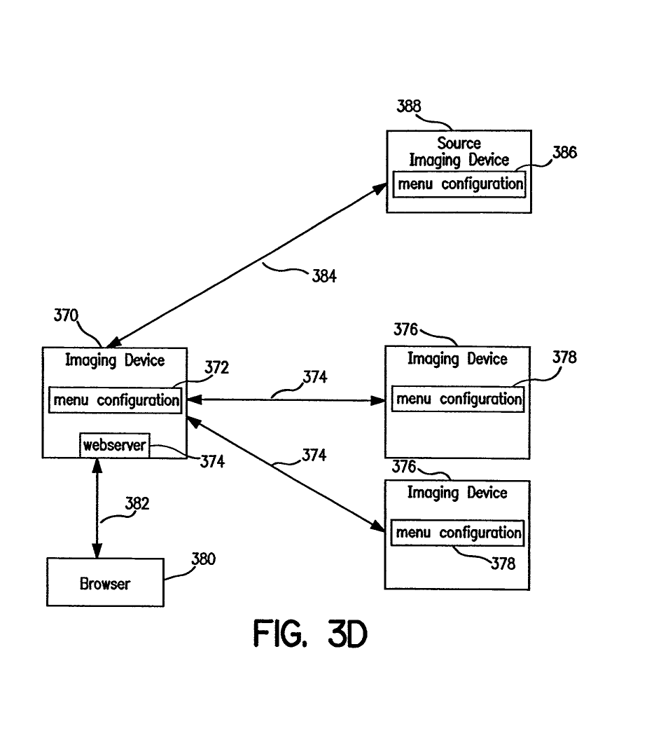

FIG. 3A is simplified diagram of another image device system embodiment of the present invention with a source imaging device 312 and a network site 306 for storage of menu configurations. In FIG. 3A, a management facility 300 copies 316 a source menu configuration 314 from a source imaging device 312 selected by an administrator and places 318 the source menu configuration on the network site 306. The menu configuration desired is then chosen and the target imaging devices 302 to configure the customized menu into are selected by the management facility 300 in response to input from the administrator. The management facility 300 then communicates 308 the network site 306 location to the target imaging devices 302 and commands them to go out and update 310 their menu configurations 304 with the desired menu configuration from the network site 306.

FIG. 3B is a simplified diagram of a further image device system embodiment of the present invention with a source imaging device 326. In FIG. 3B, a management facility 320 copies 330 a source menu configuration 328 from a source imaging device 326 selected by an administrator. The exact menu configuration desired is then chosen and the target imaging devices 322 to configure the customized menu into are selected by the management facility 320 in response to input from the administrator. The management facility 320 then communicates 332 the selected source menu configuration to the target imaging devices 322 and commands them update themselves with the selected source menu configuration.

In an additional embodiment of the present invention, an imaging device with an embedded management facility, such as an embedded webserver, can be connected to by an administrator. The administrator can utilize the embedded management facility to configure a customized menu on the imaging device or to acquire a customized menu from a source imaging device. The administrator can then utilize the imaging device and embedded management facility to configure the customized menu of the imaging device or another chosen customized menu to target imaging devices in the imaging device system. The target imaging devices can be selected from a list of imaging devices held internally in the embedded management facility of the imaging device. This list of imaging devices of the imaging device system can be entered into the embedded management facility in multiple manners which include, but is not limited to, manual entry by an administrator, loading the list of imaging devices from an external source, or generating the list of imaging devices by “discovering” imaging devices on the network. Once the list of imaging devices is entered, loaded, or discovered the administrator selects the desired target imaging devices and commands the source imaging device to configure the customized menu into the target imaging devices through the embedded management facility.

FIG. 3C is a simplified diagram of an image device system with an imaging device embodiment of the present invention that incorporates an embedded management facility. In FIG. 3C, an administrator communicates 352 with the embedded webserver management facility 344 of the imaging device 340 with a browser 350. The source menu configuration 342, 358 is either obtained internally from the imaging device 340 with the embedded webserver management facility 344 or is obtained 360 from a source imaging device 356 on the network. The imaging device 340 places 362 the selected menu configuration 342, 358 on a network site or imaging device 364. The imaging device 340 then commands 354 the one or more selected target imaging devices 346 to retrieve the selected source menu configuration 342, 358 from the network site 364 and to configure their internal menu configurations 348.

FIG. 3D is a simplified diagram of an image device system with another imaging device embodiment of the present invention that incorporates an embedded management facility. In FIG. 3D, an administrator communicates 382 with the embedded webserver management facility 374 of the imaging device 370 with a browser 380. The source menu configuration 372, 386 is either obtained internally from the imaging device 370 with the embedded webserver management facility 374 or is obtained 384 from a source imaging device 388 on the network. The imaging device 370 then configures the menus of one or more selected target imaging devices 376, copying the source menu configuration 372, 386 to the menu configurations 378 of the target imaging devices 376.

As an additional feature, imaging devices of embodiments of the present invention can be set to update one or more the customized menus once the menus have been initially configured and distributed. In these follow-up menu configurations with embodiments of the present invention, the target imaging devices, at the option of the imaging device system administrator, can periodically check the source imaging device or repository network site for changes in the menu configuration. If a change in menu configuration is noted, the target imaging devices can initiate menu configuration proceedings to update one or more of their configured menus from the source imaging device or a repository network site using the parameters of the initial menu configuration operation. Alternatively, if a menu of a source imaging device is upgraded again after being initially utilized to configure menus in a list of target imaging devices, it or the management facility can, at the option of the imaging device system administrator, upgrade the configured menus of the target imaging devices selected in the initial menu configuration process.

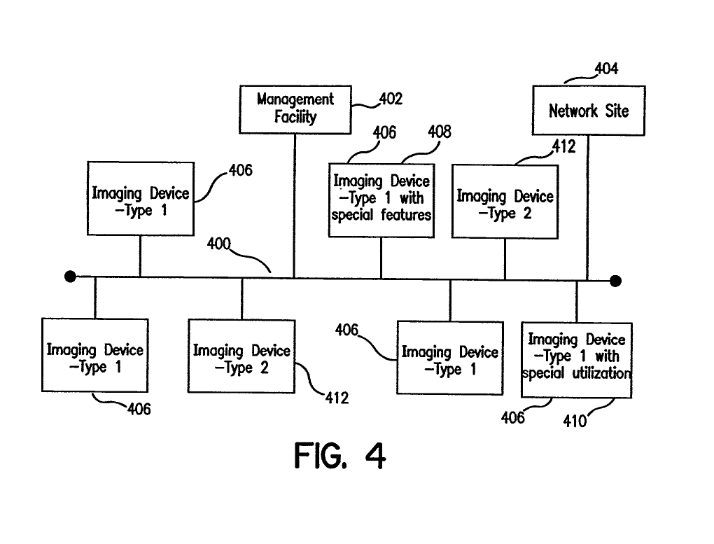

FIG. 4 is a simplified diagram of an imaging device system embodiment of the present invention with a network backplane 400, a management facility 402 for configuring menu configurations, a network site 404 for storage of menu configurations, and a first class of imaging devices 406 and a second class of imaging devices 412 that have differing imaging device menu configurations. An imaging device 408 of the first imaging device class 406 has special features (such as a document sorter, etc.) and is configured with a supplemental menu configuration that allows users and administrators to access and manage this additional functionality. Additionally, another imaging device 410 of the first imaging device class 408 has a specialized utilization in the imaging device system of FIG. 4 (such as check printing, etc.), and therefore has a differing menu configuration than the other imaging devices of the first imaging device class 408.

It is noted that alternative manners of imaging device menu acquisition and configuration across one or more imaging devices in an imaging device system in accordance with embodiments of the present invention are possible and should be apparent to those skilled in the art with the benefit of the present disclosure.

### Conclusion

Apparatus and methods for acquiring a customized menu configuration from a source imaging device and configuring a version of the menu configuration on one or more imaging devices or classes of imaging devices in a imaging device network have been described. These customized menus can be configured for one or more classes of users, administrators, or specific device purposes. Such configuration of customized imaging device menu configuration on one or more imaging devices or classes of imaging devices allows for ease of managing imaging device systems and aids user utilization of the imaging device system. Additionally, convenient imaging device menu customization of imaging device menus by equipment provider, business, network, or location is also enabled. Automated discovery of imaging devices for configuration and automated follow-up updating of menus of imaging devices that are part of the managed imaging device system is also allowed.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An imaging device system comprising:
a network;
a plurality of imaging devices coupled to the network; and
a management facility coupled to the network, wherein the management facility is adapted to acquire a menu configuration from one or more source imaging devices and to configure the menu configuration to one or more selected imaging devices of the plurality of imaging devices.

2. The imaging device system of claim 1, wherein the configured menu configuration contains situation specific sub-menus.

3. The imaging device system of claim 1, wherein the configured menu configuration has characteristics selected from the group consisting of menu characteristics specific to a user, menu characteristics specific to a class of users, menu characteristics specific to an imaging device, and menu characteristics specific to a class of imaging devices.

4. The imaging device system of claim 1, wherein the configured menu configuration requires use of a password, a username and password, or a personal identification number (PIN) to access the menu.

5. The imaging device system of claim 1, wherein the configured menu configuration is a baseline menu that is common to a class of imaging devices or to all imaging devices on the network.

6. The imaging device system of claim 1, wherein the configured menu configuration is specific to an intended utilization of the one or more selected imaging devices.

7. The imaging device system of claim 1, wherein the configured menu configuration is communicated to the selected imaging devices in a manner selected from the group consisting of being transferred from the management facility, being transferred from a source imaging device, and being transferred from a network site.

8. The imaging device system of claim 1, wherein the management facility selects the one or more imaging devices from a discovered list of imaging devices in the imaging device system.

9. The imaging device system of claim 1, wherein the management facility is an imaging device with an embedded webserver.

10. A method of configuring a menu configuration in an imaging device system comprising:
obtaining a menu configuration from one or more source imaging devices; and
setting the menu configuration of one or more selected imaging devices of the imaging device system.

11. The method of claim 10, wherein setting the menu configuration further comprises setting the menu configuration to have menu characteristics selected from the group consisting of menu characteristics specific to a user, menu characteristics specific to a class of users, menu characteristics specific to an imaging device, and menu characteristics specific to a class of imaging devices.

12. The method of claim 10, wherein setting the menu configuration further comprises setting the menu configuration with a management facility, where the management facility is selected from the group consisting of a management program, a driver, and an embedded management facility of an imaging device.

13. The method of claim 10, wherein setting the menu configuration further comprises setting the menu configuration with a management facility, where the management facility discovers the one or more imaging devices of the imaging device system.

14. The method of claim 10, wherein setting the menu configuration further comprises setting the menu configuration by communicating it to the one or more selected imaging devices from a device selected from the group consisting of a management facility, a source imaging device, and a network site.

15. A computer-usable medium having computer readable instructions stored thereon for execution by a processor to perform a method comprising: obtaining a menu configuration from one or more source imaging devices; and setting the menu configuration of one or more selected imaging devices of the imaging device system.

16. The computer-usable medium of claim 15, wherein setting the menu configuration further comprises setting the menu configuration with a management facility, where the management facility is selected from the group consisting of a management program, a driver, and an embedded management facility of an imaging device.

17. An imaging device comprising:
a network interface; and
an embedded management facility coupled to the network interface, wherein the management facility is adapted to acquire a menu configuration from one or more source imaging devices and to configure the menu configuration to one or more selected imaging devices of an imaging device system.

18. The imaging device of claim 17, wherein the menu configuration acquired from one or more source imaging devices is acquired from the imaging device itself.

19. The imaging device of claim 17, wherein the configured menu configuration has characteristics selected from the group consisting of menu characteristics specific to a user, menu characteristics specific to a class of users, menu characteristics specific to an imaging device, and menu characteristics specific to a class of imaging devices.

20. The imaging device of claim 17, wherein the configured menu configuration is communicated to the selected imaging devices in a manner selected from the group consisting of being transferred from the management facility, being transferred from a source imaging device, and being transferred from a network site.
